(19) United States
(12) Patent Application Publication
(10) Pub. No.: US 2024/0020646 A1
(43) Pub. Date: Jan. 18, 2024

(54) Multi-Factor Job Posting Score Determination and Update Recommendation

(71) Applicant: Indeed, Inc., Austin, TX (US)

(72) Inventors: Jacob Andersson, Austin, TX (US); Roman Decca, Austin, TX (US); Solomon Garger, Austin, TX (US); Tanya Zhang, San Marino, CA (US)

(21) Appl. No.: 17/865,455

(22) Filed: Jul. 15, 2022

(51) Int. Cl. G06Q 10/10; G06F 16/909; G06F 16/904

(52) U.S. Cl. CPC G06Q 10/1053; G06F 16/909; G06F 16/904

(57) ABSTRACT

Multi-factor job posting score determination and update recommendation leverages a learning model trained based on a corpus of job postings to determine scores predicting engagement success for job postings based on the specific content and type thereof and output recommendations usable to update such job postings to increase those scores. In one approach, an initial score and one or more recommendations for increasing the initial score may be determined for a job posting for publication via a software service by using a machine learning model trained based on a job posting corpus accessible to the software service to evaluate information associated with the job posting. The initial score and interactive prompts for updating the job posting according to the one or more recommendations may then be presented within a graphical user interface for the job posting.

### BACKGROUND

Job websites are effective and increasingly popular platforms for connecting skilled job seekers and job posters in need of support. A job poster may use a job website or a third party system interfacing with the job website to create a job posting for a specific type of work, and job seekers matching criteria listed in the job posting may interact with the job posting to pursue a new work opportunity. Similarly, a job seeker may use a job website to upload resumes and other documentation representing their skills and relevant background information to attract desirable job posters.

### SUMMARY

Disclosed herein are, inter alia, implementations of systems and techniques for multi-factor job posting score determination and update recommendation.

One aspect of this disclosure is a method comprising: obtaining, by a software service, first information associated with a job posting for publication via the software service; determining an initial score for the job posting by evaluating the first information against one or more models trained using a job posting corpus accessible to the software service; determining, using the one or more models and based on the first information, one or more recommendations for increasing the initial score; presenting, within a graphical user interface (GUI) rendered by the software service for the job posting, the initial score and interactive prompts for updating the job posting according to the one or more recommendations; obtaining, by the software service, second information associated with the job posting from one or more web forms accessible via the interactive prompts; determining, in real-time in response to the second information, an updated score for the job posting by evaluating the first information and the second information against the one or more models; and presenting the updated score within the GUI.

Another aspect of this disclosure is a non-transitory computer readable medium storing instructions operable to cause one or more processors to perform operations comprising: determining, for a job posting for publication via a software service, an initial score and one or more recommendations for increasing the initial score by using a machine learning model trained based on a job posting corpus accessible to the software service to evaluate first information associated with the job posting; presenting, within a GUI for the job posting, the initial score and interactive prompts for updating the job posting according to the one or more recommendations; determining, in real-time in response to second information obtained by the software service from one or more web forms accessible via the interactive prompts, an updated score for the job posting by using the machine learning model to evaluate the first information and the second information; and presenting the updated score within the GUI.

Yet another aspect of this disclosure is an apparatus comprising a memory and a processor configured to execute instructions stored in the memory to: determine, for a job posting for publication via a software service, an initial score and one or more recommendations for increasing the initial score by using a machine learning model trained based on a job posting corpus accessible to the software service to evaluate information associated with the job posting; and present, within a GUI for the job posting, the initial score and interactive prompts for updating the job posting according to the one or more recommendations.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a system for multi-factor job posting score determination and update recommendation.

FIG. 2 is a block diagram of an example of a computing device used with a system for multi-factor job posting score determination and update recommendation.

FIG. 3 is a block diagram of an example of a software service for job posting score determination and update recommendation.

FIG. 4 is a block diagram of an example of training a learning model for job posting score determination and update recommendation using a job posting corpus.

FIG. 5 is a block diagram of an example of inferencing against information associated with a job posting using a learning model to determine a score for the job posting.

FIG. 6 is an illustration of an example of a GUI including summaries of multiple job postings and scores associated therewith.

FIG. 7 is an illustration of an example of a GUI rendered by a software service including a score for a job posting and multi-factor update recommendations therefor.

FIG. 8 is a flowchart of an example of a technique for multi-factor job posting score determination and update recommendation.

### DETAILED DESCRIPTION

A typical job posting process using a job website involves the creation of a job posting using input information obtained from one or more sources, including text entered by a user of the job website describing the job associated with the job posting. For example, the text may be obtained directly at the job website from a device of the user or via a third party intermediary system which obtains that text from the device of the user and routes same to the job website for job posting creation. The text may identify one or more types of information for the job posting, including, for example, a job title, an identification of the job poster entity, a job description, desired academic and/or work experience criteria from job seekers, compensation details, a list of potential benefits, and a geographic location for the job. The user undertaking the job posting process generally will make their job posting stand out amongst those of competitors using detailed information and competitive offerings. The job posting process may be iterative, by which a user first creates a job posting and then revises it prior to and even after publication. The job website could be a web service such as Indeed, Zip Recruiter, LinkedIn, and similar. The intermediary system can include human resources information systems (HRIS) platforms and/or recruitment management systems (RMS), examples include Workday Human Capital Management, SAP SuccessFactors, Ceridian Dayforce, Greenhouse, Lever, SmartRecruiters, and Yello. Additionally, in some cases the intermediary system may be another job website, e.g., users of say a hypothetical ZipRecruiter using it as a RMS to posts job postings to Indeed. Helping users that post job postings have better performing job postings by way of specific, tailored advice that is not reducible to rules but rather reflects the deep complexity and hyper-local and time-sensitive nature of the job market can make all of the difference for that user's success in finding qualified candidates.

Job websites generally have small, mid, and large volume users undertaking these job posting processes. In one, non-limiting example, a small-volume user may correspond to an entity that has fewer than 100 employees and/or fewer than 20 concurrent job postings at a given time, a mid-volume user may correspond to an entity having between 100 and 999 employees and more than 20 concurrent job postings at a given time, and a large-volume user may correspond to an entity that has at least 1,000 employees and more than 20 concurrent job postings at a given time. Job website users may experience job posting-related challenges based on their sizes. For example, large-volume users have internal processes in place for carefully revising job posting information before publication and for monitoring and evaluating engagement by job seekers with a job posting. However, their large sizes may often result in different users handling different aspects of the posting and hiring process, making it potentially more complicated to create and update a job posting. On the other hand, typical small-volume and even many mid-volume users may not have such internal processes. However, in many cases, job postings created for a small-volume or mid-volume user may be published with important details missing which may cause those job postings to go overlooked by qualified job seekers.

The ultimate goal of a job posting is to engage a qualified job seeker with the job associated with the job posting. This requires engagements (i.e., viewings) by job seeking users of the job website with a job posting. However, in some cases, such as where important details are omitted as described above, a user may not understand what is causing low engagements with a job posting. Similarly, due to those important details being omitted, search algorithms used by the job website may not have the data needed to deliver the job posting to relevant job seekers. The job website may offer job posting-agnostic solutions to users (e.g., small-volume and mid-volume users) to increase engagements with their job postings in the form of tips appearing within various GUIs of the job website. For example, a tip may encourage users to double-check that their job postings include compensation information, as that is commonly understood to be an important detail job seekers consider when generally reviewing a job posting. However, while such generic advice may lead a user to review their job postings to ensure some relevant information is present, the quality of the advice being generic means it cannot be tailored to a specific job posting.

Furthermore, because there are so many different categories of information that go into creating a job posting and because the specific content within each of those different categories of information can vary greatly between job types, many job website users, including small-volume and mid-volume users, often do not fully understand how to optimize their job posting details for specific jobs. For example, the details that may attract a qualified job seeker to a job posting for a fast food job in rural Missouri are likely very different from those that may attract a qualified job seeker to a job posting for a technology-related job in San Francisco, California. Even where jobs are relatively close in scope and/or location, such as a call center job in Fresno, California and a customer support job in Palo Alto, California or a fast food job in rural Missouri and a fast food job in San Francisco, California, the job seekers engagement with job postings for those types of jobs may be looking for different types of information and certain specific details within corresponding job postings. Job postings which omit or sub-optimally express those types of information or specific details are likely to have lower engagements than others for similar jobs.

Importantly, however, it may be impossible for a job website user to truly understand how to optimize the job posting for a given job for several reasons. First, as described above, there is a high variability in job posting optimization, in that the details which are most important to drive engagements for one job posting will likely vary greatly from those which are important to drive engagements for another job posting, and failure to recognize this different may result in lost engagement opportunity. Second, the details which are considered most important for specific job postings may materially change over time as market activity and demand changes, and failure to both identify and map those trends to job postings may result in lost engagement opportunity. Third, due to, for example, privacy policies enacted by the job website, users may have limited or no visibility into the specific details or types of information that attracted qualified job seekers to fulfilled job postings.

Despite this, the job website has access to a corpus of job postings and corresponding data indicative of contents of job postings, engagements with such job postings, lengths of time between publication and fulfillment of such job postings, and the like. Thus, while it may be impossible for users to aggregate and model this corpus-based information for use in optimizing specific job postings, it may be possible for the job website to do so. In particular, it may be possible to train a learning model, such as a machine learning model, to recognize patterns in aggregated job posting data within a corpus of a job posting website usable and to dynamically leverage such a trained learning model at a time when a job posting is created to produce actionable output for increasing engagement success for specific job postings based on the specific details and types thereof.

Implementations of this disclosure accordingly address problems such as those described above using a system for multi-factor score determination for job postings and multi-factor job posting update recommendations. The system leverages a learning model trained based on a corpus of job postings to determine scores predicting engagement success for job postings based on the specific content and type thereof and output recommendations usable to update such job postings to increase those scores. The implementations of this disclosure include obtaining, by a software service associated with a job website, first information associated with a job posting for publication via the software service, determining an initial score for the job posting by evaluating the first information against one or more models trained using a job posting corpus accessible to the software service, determining one or more recommendations for increasing the initial score using the one or more models and based on the first information, and presenting the initial score and interactive prompts for updating the job posting according to the one or more recommendations within a GUI rendered by the software service for the job posting. The initial score is a qualitative measure of the job posting in an initial form based on the first information against similar job postings sharing certain feature criteria combinations, such as the same job title and the same job location. The training of the learning model based on the job posting corpus teaches the learning model to recognize patterns in job postings having similar feature criteria combinations. In this way, similar job posting details can be compared against a current job posting to ensure that the score accurately represents the specifics of that job posting rather than generic tips having less significance to improving the quality of the job posting. Furthermore, according to some implementations of this disclosure, second information associated with the job posting may be obtained by the software service from one or more web forms accessible via the interactive prompts, such as based on user interaction with those interactive prompts to update the job posting. Whereas the first information includes the initial contents of the job posting (i.e., information of the job posting prior to an update based on the initial score and interactive prompts), the second information includes the contents of the job posting after the update based on the initial score and interactive prompts. As such, in some cases, the second information includes all of the first information and some additional content, while in other cases, the second information may include some, but not all, of the first information and some additional content. An updated score for the job posting may then be determined in real-time in response to the second information by evaluating the first information and the second information against the one or more models, and the updated score may accordingly be presented within the GUI.

Thus, using the implementations of this disclosure, a job website such as Indeed can provide actionable output for its users to improve the quality of their job postings and thus attract more, high qualified candidates. For example, an Indeed user may create a job posting for a sales-related job. The job posting may indicate the name of the company who would be hiring the successful candidate, the job title for the sales-related job, and a specific geographic location (e.g., a city and state in the United States of America) within which the job will be performed. However, the Indeed user may create the job posting without compensation information, a job description, or desired academic and/or work experience criteria listed. Using the implementations of this disclosure, a learning model trained and operated by or otherwise on behalf of Indeed would evaluate the job posting based on, for example, the specific job title and geographic location combination initially listed in the job posting. In particular, the learning model will recognize which types of content and the kinds of content quality that are important to attracting qualified candidates based on that job title and geographic location combination. The learning model will score the job posting based on the content initially included therein as compared to the types of content and kinds of content quality that are recognized as being important based on the job title and geographic location combination. Indeed will then present output visualizing the score and opportunities to improve the job posting based on the processing performed using the learning model. By leveraging these opportunities, the Indeed user who created the job posting (or another Indeed user on the same account) may improve the job posting by adding and/or modifying content thereof, thereby resulting in a high quality job posting that will be more positively viewed by potential candidates.

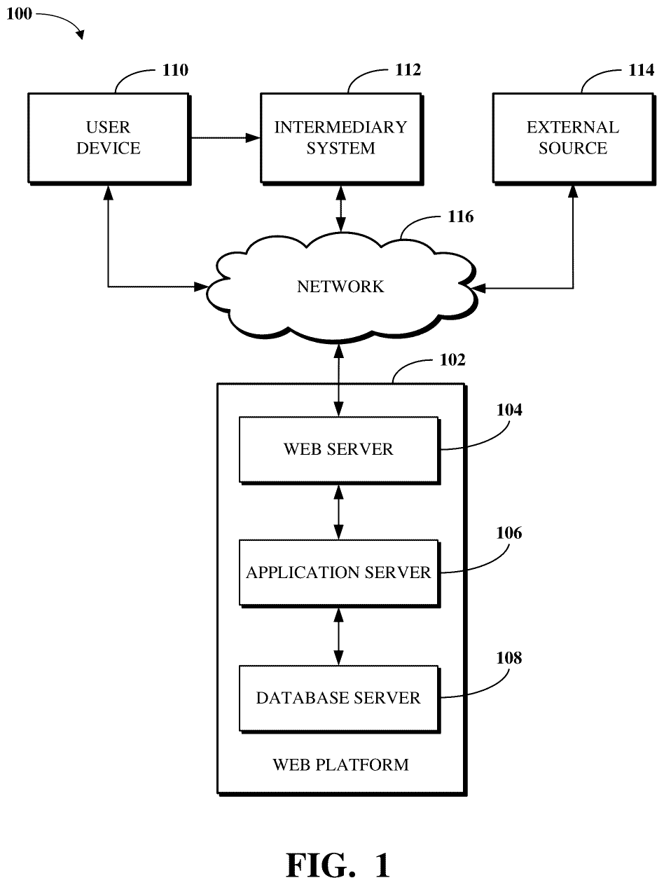

To describe some implementations in greater detail, reference is first made to examples of hardware and software structures used to implement a system for multi-factor job posting score determination and update recommendation. FIG. 1 is a block diagram of an example of a web platform system 100, which includes a web platform 102. The web platform 102 implements a job website for enabling job seeking users to upload credential details and search for job opportunities via job postings and for enabling job posting users to create and manage job postings and view engagement information associated with job seekers who have viewed and engaged with such job postings. The web platform 102 implements the job website using one or more servers, including a web server 104, an application server 106, and a database server 108. For example, the web server 104, the application server 106, and the database server 108 may be implemented by one or more servers or server racks located within one or more datacenters. A user of the web platform 102 may access the web platform 102 via a user device 110, which may, for example, be a mobile phone, a tablet computer, a laptop computer, a notebook computer, a desktop computer, or another suitable computing device or combination of computing devices.

The web server 104 processes requests (e.g., hypertext transport protocol (HTTP)-based requests) received from user devices, such as the user device 110, destined for a software service associated with the web platform 102. In particular, the web server 104 operates as a conduit to content of the web platform 102 to be served to the user device 110 in response to requests received therefrom. The content derives from the application server 106 and is routed via the web server 104 to the user device 110 for rendering at the user device 110, for example, within a web browser or other software application running at the user device.

The application server 106 runs one or more software services associated with the web platform 102 which may be delivered to the user device 110 based on requests processed via the web server 104. For example, the application server 106 may implement a web application for the job website of the web platform 102. The application server 106 can include one or more application nodes, which can each be a process executed on the application server 106 to deliver software services to the user device 110, as part of the web platform 102. An application node can be implemented using processing threads, virtual machine instantiations, or other computing features of the application server 106. In some cases where the application server 106 can includes two or more application nodes forming a node cluster, those application nodes, while implemented on a single application server 106, can run on a single hardware server or different hardware servers.

The database server 108 manages (e.g., stores or otherwise provides) data usable to deliver software services implemented by the application server 106 to the user device 110. The database server 108 may implement one or more databases, tables, or other information sources suitable for use with such a software service. The database server 108 may include a data storage unit accessible by software executed on the application server 106. A database implemented by the database server 108 may, for example, be a relational database management system, an object database, an extensible markup language (XML) database, one or more flat files, other suitable non-transient storage mechanisms, or a combination thereof. In some cases, one or more databases, tables, other suitable information sources, or portions or combinations thereof may be stored, managed, or otherwise provided by a component other than the database server 110, for example, the user device 110 or the application server 106.

In some cases, some or all of the information usable to create a job posting at the web platform 102 may derive other than from the user device 110. For example, such information may derive from one or both of an intermediary system 112 or an external source 114, such as in addition to or instead of from the user device 110.

The intermediary system 112 is software usable to route information usable to create a job posting to one or more web platforms including the web platform 102. For example, the intermediary system 112 may be an applicant tracking system (ATS). A user of an ATS may, for example, cause information associated with a job posting to be created from the ATS to each of the multiple web platforms, such as to attempt to reach a wider pool of potential job seeker candidates using different ones of those web platforms. The intermediary system 112 may obtain the information associated with the job posting directly from a user, such as via the user device 110. For example, the user device 110 may connect to a server of the intermediary system 112 to transmit text and/or other materials associated with the job posting to be created, and the intermediary system 112 may then accordingly route such obtained text and/or other materials to the multiple web platforms.

The external source 114 is an electronic communication component configured to store information in one or more contexts. For example, the external source 114 may be an online social media platform, a cloud storage system, a company website associated with the user of the user device 110, or another website or software service that at one or more times obtained and stored information which may be relevant to otherwise associated with a job posting to be created. The external source 114 may, for example, transmit such information to the web platform 102 based on a request from the web platform 102 or the user device 110 made over an application programming interface (API) call.

The user device 110, the intermediary system 112, and the external source 114 each communicates with the servers 104 through 108 of the web platform 102 via a network 116. The network 116 can be or include the Internet, a local area network (LAN), a wide area network (WAN), a virtual private network (VPN), or another public or private means of electronic computer communication capable of transferring data between devices. The network 116, or another element, or combination of elements, of the system 100 can include network hardware such as routers, switches, other network devices, or combinations thereof. For example, a datacenter at which one or more of the servers 104 through 108 are located can include a load balancer for routing traffic from the network 116 to ones of those servers at the datacenter. The load balancer can route, or direct, computing communications traffic, such as signals or messages, to respective elements of the datacenter. For example, the load balancer can operate as a proxy, or reverse proxy, for a service associated with the web platform 102 or another service provided to the user device 110, by the web server 104, the application server 106, and/or another server. Routing functions of the load balancer can be configured directly or via a DNS. In some implementations, the load balancer can operate as a firewall, allowing or preventing communications based on configuration settings.

As will be described below in further detail, the web platform system 100 in relevant part performs multi-factor job posting score determination and update recommendation in connection with job postings created at the web platform 102. In particular, the system 100 may include functionality for using multi-factor job posting score determination and update recommendation, which leverages a learning model trained based on a corpus of job postings, to determine scores predicting engagement success for job postings based on the specific content and type thereof and output recommendations usable to update such job postings to increase those scores. For example, one or more aspects of the system 100 may be configured and/or otherwise used to train a learning model, such as a machine learning model, to recognize patterns in aggregated job posting data within a corpus of a software service (e.g., a job posting website associated with the web platform 102) usable and to dynamically leverage such a trained learning model at a time when a job posting is created to produce actionable output for increasing engagement success for specific job postings based on the specific details and types thereof.

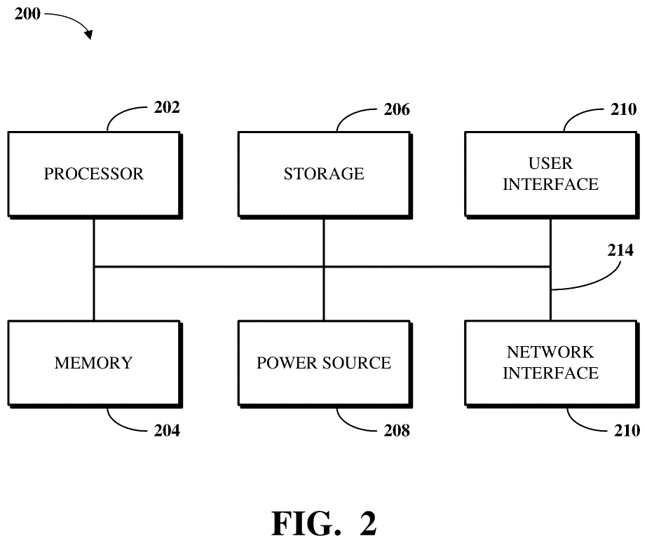

FIG. 2 is a block diagram of an example of a computing device 200 used with a web platform system, for example, the web platform system 100 shown in FIG. 1. The computing device 200 may, for example, be or be used to implement one or more of the web server 104, the application server 106, the database server 108, or the user device 110, all as shown in FIG. 1. The computing device 200 includes a processor 202, a memory 204, a storage 206, a power source 208, a user interface 210, and a network interface 212, all connected via a bus 214.

The processor 202 is a central processing unit, such as a microprocessor, having one or more processing cores. In some cases, the processor 202 can include another type of device, or multiple devices of one or more types, configured for manipulating or processing information. For example, operations performed by the processor 202 can be distributed across multiple devices that can be coupled directly (e.g., via a hardwired connection) or across a local area or other suitable type of network (e.g., via a networked connection). The processor 202 can include a cache for local storage of operating data or instructions.

The memory 204 includes one or more volatile memory components, such as random access memory (RAM), for example, static RAM (SRAM) and/or dynamic RAM (DRAM). In some cases, the memory 204 can represent a portion of memory distributed across multiple devices. In such a case, the memory 204 can include network-based memory or memory in multiple computing devices (e.g., in client-server or other arrangements) performing the operations of those multiple computing devices. The memory 204 includes operating data or instructions for immediate access by the processor 202. In one example, the memory 204 can include executable instructions corresponding to one or more application programs, which instructions can be loaded or copied, in whole or in part, from the storage 206 to the memory 204 to be executed by the processor 202, such as for performing some or all of the techniques of this disclosure. In another example, the memory 204 can include application data, such as user data, database data, functional program data, or the like. In yet another example, the memory 204 can include an operating system, for example, Microsoft Windows®, Mac OS X®, or Linux®, an operating system for a mobile device (e.g., a smartphone or tablet device), or an operating system for a non-mobile device (e.g., a mainframe computer).

The storage 206 includes one or more non-volatile memory components, such as a disk drive, a solid state drive, flash memory, or phase-change memory. The storage 206 stores operating data or instructions to be loaded or copied, in whole or in part, into the memory 204 to be executed by the processor 202. In some cases, the storage 206 can represent a portion of storage distributed across multiple devices. In such a case, the storage 206 can include network-based storage or storage in multiple computing devices (e.g., in client-server or other arrangements) performing the operations of those multiple computing devices.

The power source 208 delivers power to other components of the computing device 200. The power source 208 may, for example, be an interface (e.g., a power cable port) to an external power distribution system or a battery. In some cases, the power source 208 may include multiple power sources. For example, one of the multiple power sources can be a backup battery.

The user interface 210 includes one or more input interfaces and/or one or more output interfaces. An input interface may, for example, be a positional input device (e.g., a mouse, touchpad, or touchscreen), a keyboard, an audio input device (e.g., a microphone), or another suitable human or machine interface device. An output interface may, for example, be a display (e.g., a liquid crystal display, a cathode-ray tube, a light emitting diode display, or another suitable display) an audio output device (e.g., a speaker), or another suitable human or machine interface device.

The network interface 212 includes a wired network interface or a wireless network interface for interfacing with (i.e., connecting to) a network (e.g., the network 116 shown in FIG. 1). The network interface 212 enables the computing device 200 to communicate with other devices using one or more network protocols, for example, ethernet, transmission control protocol (TCP), internet protocol (IP), power line communication, an IEEE 802.X protocol (e.g., Wi-Fi, Bluetooth, or ZigBee), general packet radio service (GPRS), global system for mobile communications (GSM), code-division multiple access (CDMA), Z-Wave, another protocol, or a combination thereof.

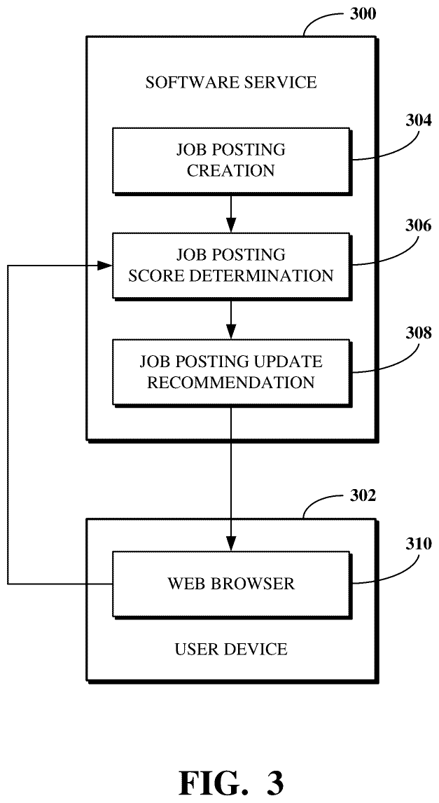

FIG. 3 is a block diagram of an example of a software service 300 for job posting score determination and update recommendation. The software service 300 is implemented by or otherwise for a web platform associated with a job posting website, for example, the web platform 102 shown in FIG. 1. In particular, the software service 300 represents job posting software of the web platform 102. The job posting software may, for example, be implemented using the application server 106 shown in FIG. 1. A user of the job posting website accesses the software service 300 via a user device 302, which may, for example, be the user device 110 shown in FIG. 1, connecting to the web platform 102.

The software service 300 includes job posting creation software 304, job posting score determination software 306, and job posting update recommendation software 308. The software 304 through 308 includes tools, such as programs, subprograms, functions, routines, subroutines, operations, and/or the like for multi-factor job posting score determination and update recommendation, such as for creating job postings and leveraging a learning model trained based on a corpus of job postings to determine scores predicting engagement success for those job postings based on the specific content and type thereof and to output recommendations usable to update such job postings to increase those scores.

The job posting creation software 304 creates a job posting based on input obtained from one or more sources. The input may, for example, be referred to as first information, which is associated with a job posting for publication via the software service 300 (i.e., the initial content originally included in or otherwise provided to be included the job posting). The one or more sources from which the input may be obtained may include the user device 302, an intermediary system (e.g., the intermediary system 112 shown in FIG. 1), or an external source (e.g., the external source 114 shown in FIG. 1).

Creating the job posting based on the first information includes producing a job posting as a draft for user review, such as by a user of the user device 302. In some cases, the draft job posting may be the first information. In other cases, the first information may be usable by the job posting creation software 304 to produce the draft job posting. For example, this may include the job posting creation software 304 mapping certain portions of the first information with certain fields of the draft job posting based on metadata associated with the first information and/or one or more API calls. The fields may, for example, include or otherwise refer to one or more of a job title, an identification of the job poster entity, a job description, desired academic and/or work experience criteria from job seekers, compensation details, a list of potential benefits, and a geographic location for the job. Typically, the first information will either include low quality information for one or more fields of the job posting or information of any quality for some, but not all, fields of the job posting. That is, the first information represents a first attempt to provide information usable for a job posting, but which can be optimized to improve the overall quality of the job posting.

The job posting score determination software 306 determines a score for the job posting created by the job posting creation software 304. A score determined using the job posting score determination software 306 generally represents a current quality level of the subject job posting, such as based on the information which is currently included in the job posting. The score may be expressed in one or more forms or formats, for example, as an integer or float value (e.g., 1 or 1.0 to 100 or 100.0), a value range (e.g., low, medium, and high), a visualization incorporating or separate from such an integer or float value or value range. The score is a useful measure to signal to a subject user of the web platform for whom or which the job posting is created how that job posting is likely to be received by job seeking users of the web platform in comparison with similar job postings for other job posting users of the web platform. In this way, the score may be considered a predictor of future engagements with the job posting by qualified job seekers and thus of a likelihood of whether and/or how quickly the job posting will be fulfilled.

The job posting score determination software 306 determines a score for a job posting created by the job posting creation software 304 in response to the creation thereof. In particular, the job posting score determination software 306 determines a score for the job posting by evaluating the contents thereof against one or more models trained using a job posting corpus accessible to the software service 300. The score determined for the job posting responsive to the creation thereof by the job posting creation software 304 may be referred to as an initial score for the job posting. The initial score represents a score for the job posting before optimizations are applied to increase the quality of the job posting. The initial score thus represents a benchmarked measure of the initial contents of the job posting (i.e., the first information) against similar job postings (i.e., historical and/or currently active job postings of the job posting corpus of the web platform which share content of one or more fields with the job posting created for the user of the user device 302).

The job posting corpus is a set, collection, compilation, aggregation, or other grouping of job postings previously published on the web platform. In one example, the job posting corpus may include or otherwise refer to all historical job postings which have been fulfilled and all job postings which remain unfulfilled for some threshold amount of time (e.g., one week or one month) after the publication thereof. In another example, the job posting corpus may include or otherwise refer to only those historical job postings and job postings remaining unfulfilled which were published within a certain time range relative to the creation of the job posting for which a score is being determined using the job posting score determination software 306 (e.g., within the past month or past year). Other examples are possible. The information included in the job posting corpus for a given historical (i.e., fulfilled or otherwise no longer currently active) or currently active (i.e., presently available for review by job seekers and thus likely unfulfilled) job posting includes some or all of the content of that job posting (e.g., one or more of job title, employer name, industry, job requirements, location, or compensation information). The job posting corpus is accessible to the software service 300 by virtue of the job posting corpus information being stored by or for the web platform and the software service 300 being a software service of the web platform.

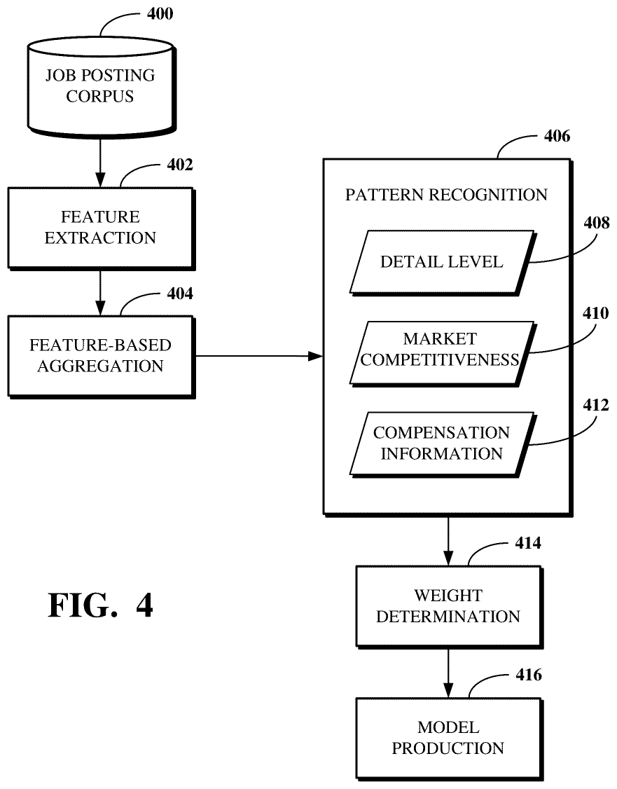

The one or more models trained using the job posting corpus are machine learning models. A machine learning model as used herein may be one or more of a neural network (e.g., a convolutional neural network, recurrent neural network, or other neural network), decision tree, vector machine, Bayesian network, genetic algorithm, deep learning system separate from a neural network, or other machine learning model. The machine learning model may be supervised or unsupervised. The machine learning model applies intelligence to identify complex patterns in the input and to leverage those patterns to produce output and refine systemic understanding of how to measure the quality of job postings. Implementations and examples of training the one or more models are described below with respect to FIG. 4.

Determining a score, such as an initial score, for a job posting by evaluating the contents thereof against one or more such models can include determining the content of certain fields within the job posting, evaluating such content against modeled content determined using the one or more models according to one or more field combinations to determine sub-scores for each of those fields, applying weights determined using the one or more models to the sub-scores, and determining the score for the job posting by compiling those weighted sub-scores.

Determining the content of fields within the job posting can include extracting or otherwise identifying the content of the first information which corresponds to each of certain fields of the job posting. Those certain fields may represent all possible fields of the job posting. Alternatively, those certain fields may correspond to a portion of the fields which are empirically understood to be the most important to job seekers (e.g., job title, employer name, industry, job requirements, location, benefits, and compensation information). In some cases, such as where the first information is obtained directly from the user device 302, the first information may be input in portions within specific text forms in which each text form is mapped to a certain job posting field. As such, in such a case, determining the content of the fields within then job posting can include using those mappings to identify such content. In other cases, such as where the first information is obtained from an intermediary system (e.g., an ATS), metadata accompanying the information or portions thereof obtained from the intermediary system may indicate the fields to which the various portions of the first information correspond. As such, in such a case, determining the content of the fields within the job posting can include using such metadata.

Evaluating the content of the job posting fields against the modeled content can include using the one or more models to evaluate a quality of the content of the job posting fields according to a certain field combination of the job posting. The certain field combination of the job posting represents information that relates the current job posting to other job postings of the same field combination. Because scores for job postings are determined relative to similar job postings, the content of the job posting fields is evaluated according to that certain field combination. In one example, the field combination may be or otherwise refer to a job type and job location combination. This evaluation prevents the job posting from being evaluated against job postings for different combinations of job type and job location, which may require different types of information be included to be considered high quality. In this way, a job posting for a customer service job in Austin, Texas can be compared against other customer service jobs in Austin, Texas to effectively determine the quality of the job posting, rather than against job postings for customer service jobs in New York, New York, project manager jobs in Austin, Texas, and project manager jobs in New York, New York.

Sub-scores determined for the respective fields represent measures of quality levels of those fields against corresponding fields from the job posting corpus, as modeled by the one or more models. Because certain fields may be more important than others, different weights may be applied to different fields. For example, a job title field may be more important than a benefits field to ensure that job seekers looking for opportunities in the job title area are able to find the job posting, and so the weight applied to the job title field is likely to be stronger (e.g., higher, when there weights are expressed in a numeric value form) than the weight applied to the benefits field. The different weights may be determined by the one or more models based on the job posting corpus. The different weights are specific to the field combination used to evaluate the job posting (e.g., the job type and job location combination). As such, weights for the same fields for other field combinations may differ.

The score for the job posting may then be determined by compiling the weighted sub-scores. Compiling the weighted sub-scores can include adding those weighted sub-scores together. The resulting sum may be represented as the score for the job posting or usable to determine the score for the job posting. For example, where the score is expressed as an integer or float value, the resulting sum of the weighted sub-scores can represent a value having a minimum of 1 or 1.0 and a maximum of 100 or 100.0. The weighted sub-scores thus each have a maximum value that is below the maximum value of the score. Generally, a weighted sub-score will have a maximum value corresponding to the weight used to determine the weighted sub-score. For example, a sub-score weighted by a strongest (e.g., highest) weight may have a maximum possible value of 25 or 25.0 whereas a sub-score weighted by a weakest (e.g., lowest) weight may have a maximum possible value of 5 or 5.0. Where the score is represented other than using a numerical form, the score may be determined based on the sum of the weighted sub-scores. For example, a score of “high” or “above average” may be determined where the sum of the weighted sub-scores exceeds 75, a score of “medium” or “average” may be determined where the sum of the weighted sub-scores is between 40 and 75, and a score of “low” or “below average” may be determined where the sum of the weighted sub-scores is below 40.

In some cases, a maximum score may be achievable for a given job posting despite one or more fields thereof being empty where the one or more models indicate that those one or more fields are non-essential for the job posting given the job type and job location combination. For example, for a job posting with the job title as Nurse Practitioner or a related nursing position, a work environment field indicating whether the subject position is for a hospital, private practice, or school may be very important to the job seeker and thus to the quality of the job posting for attracting engagements. However, the work environment field is likely to not be important at all for a job posting with the job title as On-Site Restaurant Manager. In such a case where one or more fields are determined as non-essential, the relevant fields (i.e., those except for the non-essential fields) may be scaled as part of the score determination process.

The job posting update recommendation software 308 determines one or more recommendations for increasing the score (e.g., the initial score) determined by the job posting score determination software 306. In particular, those one or more recommendations are determined using the one or more models and based on the current contents of the job posting (e.g., the first information) and the score determined by the job posting score determination software 306. The one or more recommendations are specifically tailored tips which are actionable to improve the quality of the job posting based on the initial score and may be implemented using interactive prompts presented within a GUI rendered by the software service 300 for the job posting. Although the job posting update recommendation software 308 is shown as obtaining its input from the job posting score determination software 306, in some implementations, the contents of the job posting (e.g., the first information) may be obtained by the job posting update recommendation software 308 from the job posting creation software 304 or another aspect of the software service 300 or the web platform.

The recommendations determined by the job posting update recommendation software 308 are based on the sub-scores determined by the job posting score determination software 306, such as before or after the weights are applied thereto. In this way, recommendations can be specifically tailored not only to the job posting, but more particularly to the specific fields in the job posting which include content that resulted in low sub-scores and thus is measurably of low quality. For example, a recommendation may not be determined for a job posting field which had a relatively high sub-score (e.g., a sub-score having a value that was at least 80% of the maximum possible score therefor), but a recommendation may be determined for job posting fields which had relatively low sub-scores (e.g., sub-scores having a value that were less than 80% of the maximum possible score therefor).

Accordingly, the job posting update recommendation software 308 may first identify the fields for which recommendations are to be determined. For all other fields (i.e., those for which recommendations will not be determined), a standardized output indicating that those fields are ready for publication due to their already being high quality may be prepared for output. For the fields for which recommendations are to be determined, however, the job posting update recommendation software 308 may first separate those fields into one of two groups based on the sub-scores thereof. Where the sub-scores have a minimum value indicating that the fields are empty, recommendations may be provided as indicating to fill out those fields. In some cases, the recommendations can include language suggestions derived from one or more historical job postings of the job posting corpus which were of measurably high quality. Where the sub-scores have higher than the minimum value indicating that the fields are not empty, the content of those individual fields may be evaluated against the content of corresponding fields modeled using the one or more models (e.g., from the job posting corpus). For example, the content of a given field may be evaluated using natural language processing and comparing the output of such natural language processing against modeled values of the corresponding fields.

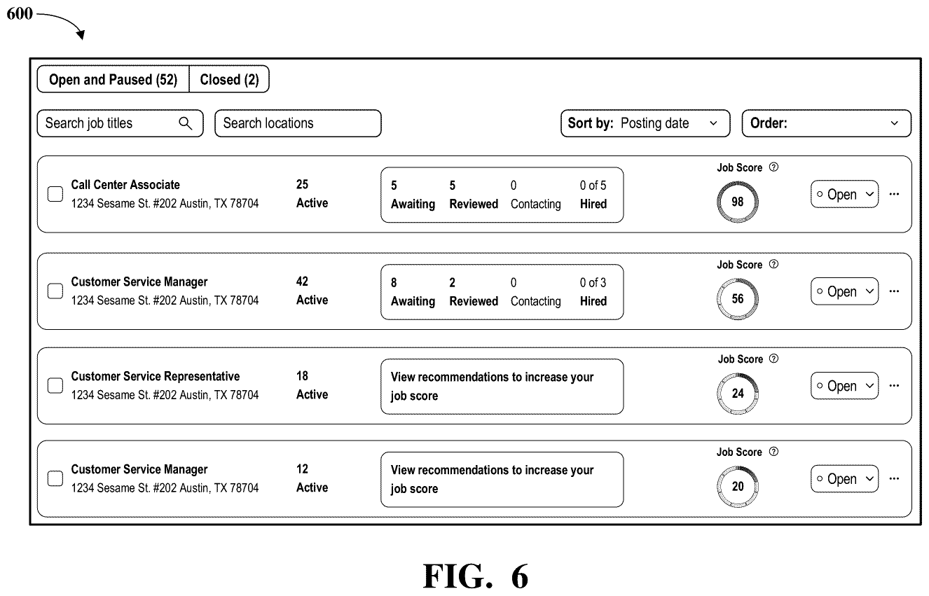

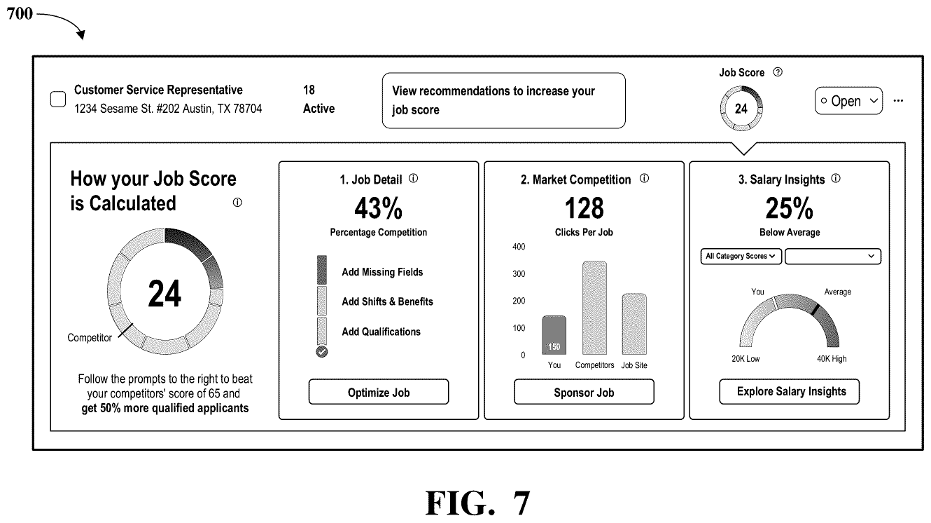

The score determined by the job posting score determination software 306 and the recommendations determined by the job posting update recommendation software 308 may be presented to the user of the user device 302 within a GUI rendered by the software service 300 for the job posting. For example, the score may be represented within a visualization presented within the GUI and the recommendations may be represented by interactive prompts presented within the GUI. The GUI may be output for display to the user device 302, such as via instructions usable by a web browser 310 running at the user device 302 to render the GUI at the user device 302. In some cases, an indication of a degree to or amount by which a score for a job posting may increase where a recommendation (e.g., add content within one or more currently empty field(s) of the job posting, increase the compensation by X amount, enable remote work, or modify the job description using certain recommended language) is implemented may be represented within the GUI in connection with a corresponding interactive prompt. Implementations and examples of visualizations for scores and interactive prompts for recommendations are described below with respect to FIGS. 6 and 7.

The processing performed by the job posting score determination software 306 and the job posting update recommendation software 308 may be repeated for a given posting based on updates to the job posting. For example, in response to an initial score and accompanying recommendations being presented to the user of the user device 302 (e.g., via a GUI rendered by the software service 300), second information associated with the job posting may be obtained. For example, the second information may be text input originating at the user device 302 and obtained by the software service 300 from one or more web forms accessible via the interactive prompts presented in connection with the recommendations. In some cases, the second information may be received a short time after the presentation of the initial score and accompanying recommendations. In other cases, the second information may be received hours or days later. In either case, the job posting score determination software 306 may determine an updated score for the job posting in real-time in response to the second information by evaluating the first information and the second information against the one or more models. The updated score may then be presented within the GUI rendered for the job posting. In some cases, further recommendations may be determined by the job posting update recommendation software 308 based on the updated score and presented within the GUI along with the updated score, in the manner as described above.

In an example use case, to illustrate the functionality of the software service 300, first information associated with a job posting is obtained by the software service 300 from an ATS and used by the job posting creation software 304 to create the job posting. The job posting score determination software 306 determines an initial score for the job posting by evaluating the first information against one or more models trained using a job posting corpus accessible to the software service 300. The job posting update recommendation software 308 then determines one or more recommendations for increasing the initial score using the one or more models and based on the first information. The initial score and interactive prompts for updating the job posting according to the one or more recommendations are then presented within a GUI rendered by the software service 300 for the job posting, which GUI may be output for display within the web browser 310 at the user device 302. Thereafter, the software service 300 may obtain second information associated with the job posting from one or more web forms accessible via the interactive prompts. The job posting score determination software 306 may then determine, in real-time in response to the second information, an updated score for the job posting by evaluating the first information and the second information against the one or more models. The updated score may finally be presented within the GUI rendered for the job posting.

The visualization of the score and the interactive prompts for the recommendations are presented within the GUI rendered for the job posting to incentivize the user of the user device 302 to update the job posting. In particular, the visualization of the score and the interactive prompts for the recommendations may represent the complete set of information which is actionable by the user of the user device 302 to understand whether and how to update a job posting. The presentation of the visualization of the score and the interactive prompts for the recommendations within the GUI rendered for the job posting makes the update process efficient by not requiring the user of the user device 302 to obtain such actionable information from multiple pages or other sources, thereby providing a single location at which score information and recommendation information can be viewed. For example, whereas a typical web platform user may have previously created a job posting and waited some amount of time (e.g., one or two days) to see how it performed before adjusting it, the presentation of the visualization of the score and interactive prompts here enable immediate action by predicting performance using the trained learning model.

The feature combination described herein by example is a job title and job location combination as those two pieces of information are generally amongst the most likely to have an effect on job seeker engagement with a job posting. However, the feature combination may correspond to additional or other fields. For example, the feature combination may correspond to a combination of two or more of a job title, industry type, job location, company size, company age, or company turnover rate.

Although the software service 300 is shown herein as including the job posting creation software 304, the job posting score determination software 306, and the job posting update recommendation software 308, in some implementations, one or more of those software components may be included in a different aspect of the web platform. For example, the job posting creation software 304 may be included in a data ingestion aspect of the web platform rather than in the software service 300. Furthermore, although the job posting creation software 304, the job posting score determination software 306, and the job posting update recommendation software 308 are shown as separate software components, in some implementations, two or all of them may be combined into a single software component, whether included in the software service 300 or otherwise.

The software service 300 is described above as being web-based, such as by the use of the web browser 310 to access and communicate with the software service 300. However, in some implementations, the software service 300 may instead or additionally be application-based. For example, in an application-based approach of the software service 300, the user device 302 may include a software application (e.g., a client application configured to interact with the software service 300 as server-side software of the web platform 102) for connecting the user device 302 to the software service 300. For example, where the user device 302 is a mobile device such as a smartphone or tablet computer, the software application may be downloaded from an operating system-specific application marketplace and run at the mobile device independent of web browser software at the mobile device to access the software service 300.

In some implementations, creating the job posting using the job posting creation software 304 can include publishing the job posting for viewing by other users of the web platform, such as prior to processing by the job posting score determination software 306. For example, creating the job posting using the job posting creation software 304 can include ingesting the first information from an intermediary system, an external source, and/or the user device 302 and accordingly publishing the job posting based on the first information responsive to such ingestion. In such a case, the job posting score determination software 306 and the job posting update recommendation software 308 operate against an already-published job posting.

FIG. 4 is a block diagram of an example of training a learning model for job posting score determination and update recommendation using a job posting corpus 400. The training process described with respect to FIG. 4 is performed using one or more software components of a web platform associated with a job website, for example, the web platform 102 shown in FIG. 1. In one non-limiting example, the training process shown herein may be performed using the software service 300 shown in FIG. 3, in which case the software components used for the training process may be those shown in FIG. 3 and/or other software components. For example, the software service 300 or another aspect of the web platform 102 may include training software for performing the training process hereof.

To train the learning model, which is a machine learning model trained to recognize patterns in one or more criteria of untagged job posting data from the job posting corpus 400, the training process first performs feature extraction 402 against job posting data of the job posting corpus 400. The job posting corpus 400 stores data associated with tens, hundreds, thousands, or larger quantities of job postings. The data includes contents of the job postings and analytical data associated with the job postings, such as lengths of time the job postings remain published, numbers of engagements which led to applications for the subject job, and numbers of engagements without application for the subject job. In some cases, the entirety of the job posting corpus 400 may be utilized for the training process. In other cases, a freshness policy may dictate which job posting corpus 400 data can be used for the training process (e.g., job postings published within the past six months or one year).

Performing the feature extraction 402 includes identifying specific content of job postings of the job posting corpus. For example, performing the feature extraction 402 can include identifying content within one or more fields of the job postings, including, without limitation, job title fields and job location fields thereof. Next, feature-based aggregation is performed against the extracted features to group the job postings having the same content. For example, all job postings having the same job type and job location may be grouped together.

Next, pattern recognition 406 is performed against the feature aggregated groups of job postings to recognize patterns in criteria of the job posting data from the job posting corpus 400. The pattern recognition 406 may be performed against one or more criteria related to the feature aggregated groups of job postings. As shown, the criteria against which the pattern recognition 406 is performed include a detail level criterion 408, a market competitiveness criterion 410, and a compensation information criterion 412.

The detail level criterion 408 concerns the degree to which fields of a given job posting are filled out and the quality of the details thereof. As has been described herein, there are various fields in a job posting, and some are more important than others based on the specific job type. Performing the pattern recognition 406 against the detail level criterion 408 includes evaluating the details of the fields of the various job postings of the feature aggregated groups to determine which details of which fields are important for which feature aggregated groups and the degree to which such details influence engagements. For example, performing the pattern recognition 406 can include evaluating data pairs including first data corresponding to numbers of engagements for the various job postings of the feature aggregated group and second data corresponding to the details within the fields of those job postings to recognize patterns in which types of details are correlated with higher numbers of engagements.

The market competitiveness criterion 410 concerns the competitiveness of one or more types of market related to job postings of the feature aggregated groups of job postings. Generally, the competitiveness of a market refers to the supply of job postings in that market relative to the demand for job seekers to fulfill those job postings. The types of market related to a job posting may, for example, include a geographical market that relates to the competitiveness of a certain job type within a certain geographic region, a job number market that relates to the average number of job postings available for a certain job type at a given time, and a competitor market that relates to the average number of companies that are pursuing positions for a certain job type at a given time. Performing the pattern recognition 406 against the market competitiveness criterion 410 includes evaluating one or more of the various types of market against the job postings of a feature aggregated group to determine which job postings had the highest engagements in which markets and accordingly which fields of those job postings included either some content or high quality content. In some cases, the evaluation may be performed for a single market. For example, because the number of job seekers who search for and/or interact with job postings in a given market, such numbers from other markets may distort the competitiveness finding for the given market. In some cases, the evaluation may be performed for combinations of markets.

The compensation information criterion 412 concerns the competitiveness of the compensation offered within a job posting relative to similar job postings in the same feature aggregated group. Performing the pattern recognition 406 against the compensation information criterion 412 includes evaluating the compensation information reflected in the job postings of a feature aggregated group of job postings to correlate various amounts or amount ranges of compensation with numbers of engagements to recognize patterns in which compensation offerings resulted in which levels of engagement. The evaluation of the compensation information can be performed in a number of different manners including, for example, by based on median, average, or interquartile range values. Ultimately, the compensation information criterion 412.

The pattern recognition 406 is performed to train a learning model to recognize the patterns according to the criteria 408 through 412. The trained learning model can thus be usable to predict engagements with a job posting based on certain content and data of that job posting. As a final step of the training process, weight determination 414 may be performed to determine weights for certain criteria and/or fields of job postings of the feature aggregated groups of job postings. For example, the weight determination 414 can evaluate the patterns recognized by the pattern recognition to determine the fields of job postings that are correlated with the highest numbers of engagements for a given feature aggregated group of job postings. Such fields may be assigned a strongest (e.g., highest) weight, for example. Model production 416 produces as output the trained learning model resulting from the completed training process. The learning model may be supervised or unsupervised, based on the presence of tagging data, metadata, or like information usable to guide the pattern recognition 406.

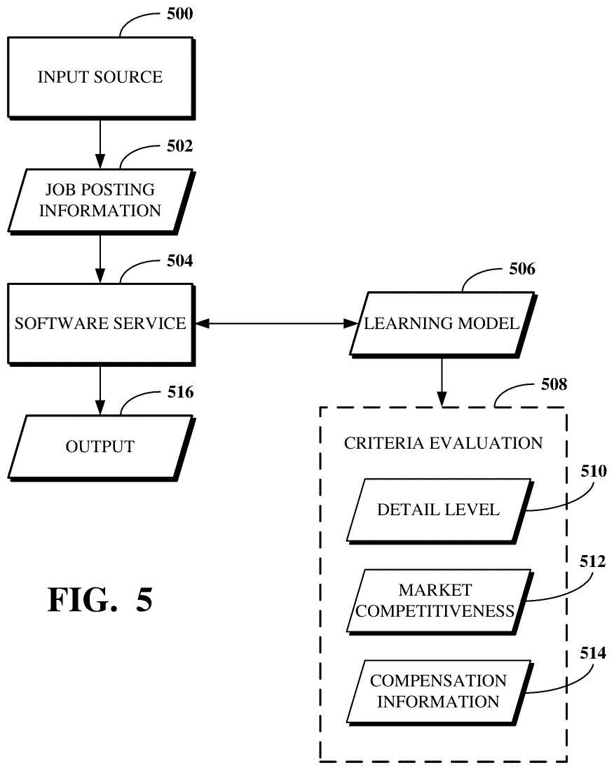

FIG. 5 is a block diagram of an example of inferencing against information associated with a job posting using a learning model to determine a score for the job posting. The inferencing process described with respect to FIG. 5 is performed using one or more software components of a web platform associated with a job website, for example, the web platform 102 shown in FIG. 1. In one non-limiting example, the inferencing process shown herein may be performed using the software service 300 shown in FIG. 3, in which case the software components used for the inferencing process may be those shown in FIG. 3 and/or other software components. For example, the job posting score determination software 306 and the job posting update recommendation software 308 of the software service 300 as shown in FIG. 3 can perform the inferencing process hereof.

An input source 500 connected to the web platform provides job posting information 502, such as which is referred to herein as first information usable to create a job posting. A software service 504, which may, for example, be the software service 300, obtains the job posting information 502 and processes same as described in FIG. 3 using one or more models including a learning model 506. The learning model 506 is a supervised or unsupervised machine learning model trained to recognize patterns in one or more criteria of job posting data from a job posting corpus of the web platform for each of multiple job types and multiple job locations. For example, the learning model 506 may be a learning model resulting from the training process shown and described with respect to FIG. 4.

Based on the patterns, the learning model 506 assigns different weights to the one or more criteria as part of a criteria evaluation process 508. As shown, the one or more criteria include a detail level criterion 510, a market competitiveness criterion 512, and a compensation information criterion 514, which may, for example, correspond respectively to the criteria 408 through 412 shown in FIG. 4. Accordingly, the learning model 506 can be used to determine a score (e.g., the initial score) for the job posting created using the job posting information 502 by can include inferencing the job posting information 502 against at least some of the criteria 510 through 514 according to one or more weights determined for the job posting based on a field combination for the job posting (e.g., a job type and job location combination).

The learning model 506 is further used to determine one or more recommendations for increasing the score for the job posting. For example, the recommendations may be based on correlations recognized when training the learning model 506 between types of information included in job postings of the job posting corpus, such correlations between job posting details and varying levels of engagement with the subject job postings. The recommendations may be determined on a sub-score basis for specific fields of the job posting created based on the job posting information 502, for example, based on the fields recognized as being important to the job posting based, for example, on the job type and job location combination. The software service 504 ultimately presents output indicative of the score determined for the job posting using the learning model 506 and the one or more recommendations for increasing the score.

In some implementations, the web platform may enable select job postings to be designated as high priority. A high priority designation may cause a designated job posting to be more readily accessible to job seekers via searches on the web platform. In some such implementations, a recommendation determined using the learning model can indicate to designate a job posting as high priority. For example, the recommendation to designate the job posting as high priority may be based on the initial score for the job posting being below a threshold and/or a high market competitiveness for the market to which the job posting corresponds. The high priority designation may be implemented by the user interacting with the one or more interactive prompts output based on the recommendations.

FIG. 6 is an illustration of an example of a GUI 600 including summaries of multiple job postings and scores associated therewith. The GUI 600 is output for display to a user device, for example, the user device 302 shown in FIG. 3, to view job postings associated with a user account of a web platform accessed using the user device. Four job postings are shown, in which each of the four job postings corresponds to a different row of the GUI 600. For each such job posting, a job title and job location are shown at a left side of the row, reporting information indicative of engagements with the job posting are shown in the middle of the row, and a visualization of a job score determined for the job posting is shown at a right side of the row. A user of the user device may interact with (e.g., click on) one of the rows shown in the GUI 600 to expand the information associated with that job posting for display at the user device.

FIG. 7 is an illustration of an example of a GUI 700 rendered by a software service including a score for a job posting and multi-factor update recommendations therefor. In particular, the GUI 700 is output for display to a user device, as described above with respect to FIG. 6, in response to an interaction with the job posting shown in the third row of the GUI 600. The GUI 700 is rendered by the software service (e.g., the software service 300 shown in FIG. 3) for the job posting shown therein. Information similar to that presented in the row for the job posting in the GUI 600 appears at a top of the GUI 700. A bottom frame including an enlarged visualization of the job score and three boxes each including a different recommendation for increasing the job score is shown below that top row information. The visualization for the job score here is represented as a color wheel (noting the reproduction herein appears in grey scale, shades of gray from dark to light are used to represent corresponding gradients between colors) with a numerical form of the job score appearing in the middle of the color wheel. The visualization shown in the GUI 700 is one of many possible examples which may be used.

To the right of the enlarged visualization within the GUI 700 are the three boxes each including a different recommendation for increasing the job score. The leftmost box corresponds to the job detail criterion for evaluating the job posting and indicates that the job posting is only 43 percent complete, such as because several fields have been left empty. An interactive prompt labeled “Optimize Job” appears at the bottom of that box which, if interacted with, will enable the user to add text to the subject fields of the job posting. The middle box corresponds to the market competitiveness criterion for evaluating the job posting and indicates that the predicted number of engagements with the job posting is below the average number for the user, competitors, and the job website implemented by the web platform. An interactive prompt labeled “Sponsor Job” appears at the bottom of that box which, if interacted with, will enable the user to designate the job posting as a high priority job posting via sponsorship within the job website. A rightmost box corresponds to the compensation criterion for evaluating the job posting and indicates that the compensation represented within the job posting is 25 percent below the average compensation offered for similar job postings (e.g., job postings with the same job title and job location combination). An interactive prompt labeled “Explore Salary Insights” appears at the bottom of that box which, if interacted with, will enable the user to adjust the compensation information listed within the job posting and potentially view more detailed information for compensations reflected in the similar job postings.

The interaction with any of the interactive prompts shown in the GUI 700 may result in a real-time update to the job score shown therein. For example, second information obtained based on an interaction with any of the interactive prompts shown may be used to re-evaluate the job posting as described above. Where a change in the job score is determined based on that re-evaluation, the change may be immediately represented within the GUI 700 such as by a change to the visualization for the job score. In some cases, where further recommendations may be available to further increase the job score, those further recommendations may be presented in boxes similar to those shown in the GUI 700.

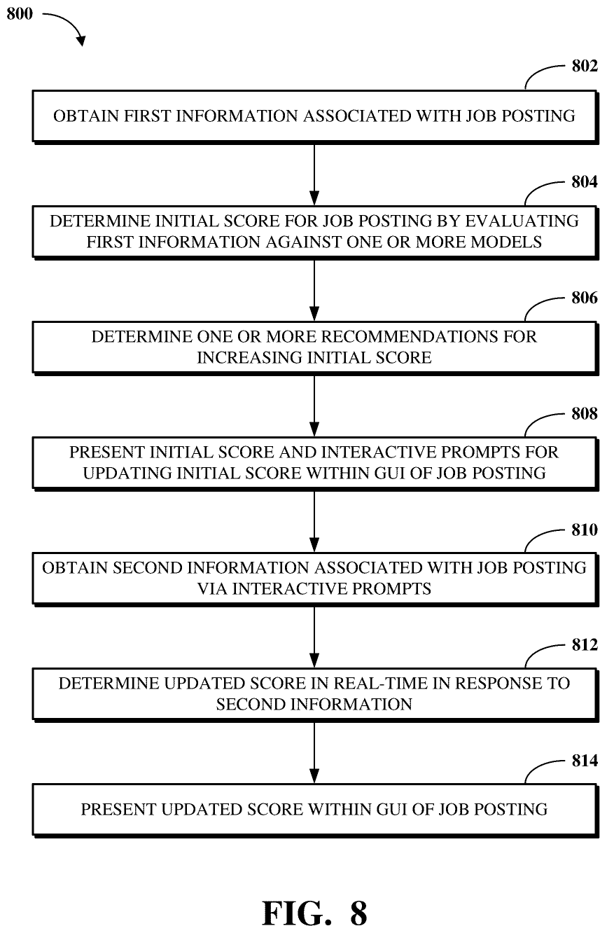

To further describe some implementations in greater detail, reference is next made to examples of techniques which may be performed by or using a system for multi-factor job posting score determination and update recommendation. FIG. 8 is a flowchart of an example of a technique 800 for multi-factor job posting score determination and update recommendation. The technique 800 can be executed using computing devices, such as the systems, hardware, and software described with respect to FIGS. 1-7. The technique 800 can be performed, for example, by executing a machine-readable program or other computer-executable instructions, such as routines, instructions, programs, or other code. The steps, or operations, of the technique 800 or another technique, method, process, or algorithm described in connection with the implementations disclosed herein can be implemented directly in hardware, firmware, software executed by hardware, circuitry, or a combination thereof.

For simplicity of explanation, the technique 800 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 802, first information associated with a job posting for publication via a software service is obtained by the software service. The first information represents information used to create the job posting. The first information may be directly obtained from a user device associated with a user for whom or which the job posting is created (e.g., a company as the employer or contractor associated with the job posting) or it may be obtained via an intermediary system, such as an ATS. The first information includes text mappable to one or more fields of the job posting, generally, although not always, without prior optimization as disclosed herein.

At 804, an initial score for the job posting is determined. In particular, the initial score for the job posting is determined by evaluating the first information against one or more models trained using a job posting corpus accessible to the software service. As described above, the initial score may be determined based on weighted sub-scores for various fields of the job posting, for example, according to a field combination such as a job type and job location combination for the job posting.

The one or more models include a machine learning model trained to recognize patterns in one or more criteria of untagged job posting data from the job posting corpus for each of multiple job types and multiple job locations. Based on the patterns, the machine learning model assigns different weights to the one or more criteria for different job type and job location combinations derived from the multiple job types and the multiple job locations. Accordingly, determining the initial score for the job posting can include determining one or more weights of the different weights to use for the job posting based on a job type and job location combination associated with the job posting, and using the machine learning model to inference the first information against at least some of the one or more criteria according to the one or more weights. In this way, the initial score represents a qualitative measure (i.e., a measure of quality) of the job posting against other job postings of the job type and job location combination, such as by indicating how the quality of the job posting compares to other job postings of the job type and job location combination based on details recognized by the machine learning model as being important to that job type and job location combination. In some cases, ones of the different weights are updated over time based on tracked user engagements with job postings of the job posting corpus. In some implementations, the technique 800 may include training the one or more models using the job posting corpus.

In some cases, the one or more criteria correspond to a job posting detail level, an inferred job posting market competitiveness, and job posting compensation information. In such a case, the first information may include a job posting detail level for the job posting, an inferred job posting market competitiveness for the job posting, and/or job posting compensation information for the job posting. For example, the initial score may be determined based on a first sub-score determined based on the job posting detail level for the job posting and a first weight of the one or more weights, a second sub-score determined based on the inferred job posting market competitiveness for the job posting and a second weight of the one or more weights, and a third sub-score determined based on the job posting compensation information for the job posting and a third weight of the one or more weights. In such a case, the one or more recommendations may indicate to change details for the job posting when the first sub-score is below a first threshold, to increase a priority level of the job posting within the software service when the second sub-score is below a second threshold, and/or to change compensation information for the job posting when the third sub-score is below a third threshold.

In some cases, a weight assigned to the job posting detail level for a given job type and job location combination may be based on a quality of details included in job postings of the given job type and job location combination within the job posting corpus, and the quality of details may be measured using a contextual machine learning model trained for natural language processing of job postings. In some cases, a weight assigned to the inferred job posting market competitiveness for a given job type and job location combination may be based on a volume of job postings of the given job type and job location combination within the job posting corpus. In some cases, a weight assigned to the job posting compensation information for a given job type and job location combination may be based on an average compensation value computed for job postings of the given job type and job location combination within the job posting corpus.

At 806, one or more recommendations for increasing the initial score are determined using the one or more models and based on the first information. As described above, the one or more recommendations may be determined based on ones of the weighted sub-scores that are below a threshold or otherwise lower than other ones of the weighted sub-scores. The recommendations indicate actions to take to increase one or more such sub-scores and thus the overall score for the job posting. For example, the recommendations can be based on correlations recognized by the one or more models based on content of and data associated with job postings of the job posting corpus and engagements with those job postings. Examples of such recommendations may include, but are not limited to, adding text into empty fields, replacing existing text with suggested text determined based on the aforesaid correlations, designating a high priority for the job posting such as via a sponsorship of the job posting within the web platform, increasing a compensation offering referenced in the job posting, allowing remote work opportunities for the job posting, clarifying a job description or job title for the job posting, or the like or a combination thereof.

At 808, the initial score and interactive prompts for updating the initial score according to the one or more recommendations are presented within a GUI rendered by the software service for the job posting. For example, the GUI may be the GUI 700 shown in FIG. 7. The GUI may include a visualization of the initial score. In one example, the visualization may be a color wheel visualization of the initial score. In other examples, the visualization may be a speedometer, a thermometer, or a progress bar. In such a case, presenting the initial score within the GUI can include presenting the visualization (e.g., the color wheel visualization) within the GUI in response to the initial score. The interactive prompts may be presented in connection with the visualization of the initial score and indicate manners by which the job posting may be improved to increase the initial score. In some implementations, a single interactive prompt may be presented within the GUI in connection with the one or more recommendations.

At 810, at some point after the initial score and the interactive prompts are presented within the GUI rendered by the software service for the job posting, second information associated with the job posting is obtained by the software service from one or more web forms accessible via the interactive prompts. The second information represents changes to the first information based on the one or more recommendations. In some cases, the second information is obtained directly from a web service associated with the web platform in response to content (e.g., text) entered directly within a web form of that web service. For example, the second information may correspond to newly entered details or other text to include within one or more previously empty or insufficient fields of the job posting. In some implementations, where a single interactive prompt is presented within the GUI, all of the second information may be obtained based on forms accessed via a user interaction with that single interactive prompt. For example, the single interactive prompt may guide the user through multiple web forms each corresponding to a different portion of the second information. In another example, the single interactive prompt may guide the user to a single web form at which a batch of input comprising all of the second information may be entered.

At 812, an updated score for the job posting is determined in real-time in response to the second information. In particular, the updated score is determined by evaluating the first information and the second information against the one or more models trained using the job posting corpus accessible to the software service. The updated score may be determined as or substantially as the initial score described above is determined, but with reference to both the first information and the second information rather than based on the first information alone.

At 814, the updated score is presented within the GUI rendered by the software service for the job posting. The updated score is, in particular, presented in real-time within the GUI in response to the updated score. Presenting the updated score in real-time within the GUI in response to the updated score can include replacing a previous presentation of the initial score within the GUI with the updated score. For example, a visualization previously configured to represent the initial score may be reconfigured or otherwise replaced so as to now represent the updated score. In one particular example, where the GUI includes a color wheel visualization of the initial score prior to the second information, presenting the updated score within the GUI can include updating the color wheel visualization to reflect the updated score in real-time in response to the updated score.

In some cases, recommendations presented may not be immediately acted upon, such as due to internal policies of an account used by a user who created a subject job posting. In one example, the initial score for a job posting may be partially determined based on compensation information for the job posting either not being identified (e.g., because the first information does not include compensation information) or not being competitive relative to compensation of the subject market as determined using the trained learning model. In such a case, the one or more recommendations may include a recommendation to add or increase compensation offerings for the job posting. However, internal processes for a company associated with that user require that user to obtain supervisory approval to adjust compensation information listed in the job posting or otherwise add same thereto, an interactive prompt related to compensation information may not be interacted with to result the second information. In such a case, the user may nonetheless deliver such a recommendation to their supervisor to inform them of the importance of adding or updating the compensation information for the job posting. The user may thereafter add or update such compensation information at a later time, serving as third information used to further update the job posting.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, Python, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “component” and “aspect” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of this disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
obtaining, by a software service, first information associated with a job posting for publication via the software service;
determining an initial score for the job posting by evaluating the first information against one or more models trained using a job posting corpus accessible to the software service;
determining, using the one or more models and based on the first information, one or more recommendations for increasing the initial score;
presenting, within a graphical user interface rendered by the software service for the job posting, the initial score and interactive prompts for updating the job posting according to the one or more recommendations;
obtaining, by the software service, second information associated with the job posting from one or more web forms accessible via the interactive prompts;
determining, in real-time in response to the second information, an updated score for the job posting by evaluating the first information and the second information against the one or more models; and
presenting the updated score within the graphical user interface.

2. The method of claim 1, wherein the one or more models include an unsupervised machine learning model trained to recognize patterns in one or more criteria of untagged job posting data from the job posting corpus for each of multiple job types and multiple job locations, and
wherein, based on the patterns, the unsupervised machine learning model assigns different weights to the one or more criteria for different job type and job location combinations derived from the multiple job types and the multiple job locations.

3. The method of claim 2, wherein determining the initial score for the job posting comprises:
determining one or more weights of the different weights to use for the job posting based on a job type and job location combination associated with the job posting; and
inferencing, using the unsupervised machine learning model, the first information against at least some of the one or more criteria according to the one or more weights.

4. The method of claim 3, wherein the initial score represents a qualitative measure of the job posting against other job postings of the job type and job location combination.

5. The method of claim 2, wherein the one or more criteria correspond to a job posting detail level, an inferred job posting market competitiveness, and job posting compensation information, and
wherein the first information includes a job posting detail level for the job posting, an inferred job posting market competitiveness for the job posting, and job posting compensation information for the job posting.

6. The method of claim 5, wherein the initial score is determined based on a first sub-score determined based on the job posting detail level for the job posting and a first weight of the one or more weights, a second sub-score determined based on the inferred job posting market competitiveness for the job posting and a second weight of the one or more weights, and a third sub-score determined based on the job posting compensation information for the job posting and a third weight of the one or more weights,
wherein the one or more recommendations indicate to change details for the job posting when the first sub-score is below a first threshold,
wherein the one or more recommendations indicate to increase a priority level of the job posting within the software service when the second sub-score is below a second threshold, and
wherein the one or more recommendations indicate to change compensation information for the job posting when the third sub-score is below a third threshold.

7. The method of claim 5, wherein a weight assigned to the job posting detail level for a given job type and job location combination is based on a quality of details included in job postings of the given job type and job location combination within the job posting corpus, and wherein the quality of details is measured using a contextual machine learning model trained for natural language processing of job postings.

8. The method of claim 5, wherein a weight assigned to the inferred job posting market competitiveness for a given job type and job location combination is based on a volume of job postings of the given job type and job location combination within the job posting corpus.

9. The method of claim 5, a weight assigned to the job posting compensation information for a given job type and job location combination is based on an average compensation value computed for job postings of the given job type and job location combination within the job posting corpus.

10. The method of claim 2, wherein ones of the different weights are updated over time based on tracked user engagements with job postings of the job posting corpus.

11. The method of claim 1, wherein the graphical user interface includes a color wheel visualization of the initial score prior to the second information, and wherein presenting the updated score within the graphical user interface comprises:
updating the color wheel visualization to reflect the updated score in real-time in response to the updated score.

12. The method of claim 1, wherein the second information represents changes to the first information based on the one or more recommendations.

13. A non-transitory computer readable medium storing instructions operable to cause one or more processors to perform operations comprising:
determining, for a job posting for publication via a software service, an initial score and one or more recommendations for increasing the initial score by using a machine learning model trained based on a job posting corpus accessible to the software service to evaluate first information associated with the job posting;
presenting, within a graphical user interface for the job posting, the initial score and interactive prompts for updating the job posting according to the one or more recommendations;
determining, in real-time in response to second information obtained by the software service from one or more web forms accessible via the interactive prompts, an updated score for the job posting by using the machine learning model to evaluate the first information and the second information; and
presenting the updated score within the graphical user interface.

14. The non-transitory computer readable medium of claim 13, wherein the machine learning model is an unsupervised machine learning model trained to recognize patterns in untagged job posting data from the job posting corpus according to a job posting detail level criterion, an inferred job posting market competitiveness criterion, and a job posting compensation information criterion applied to each of multiple job types and multiple job locations, and
wherein, based on the patterns, the unsupervised machine learning model assigns different weights to each of the job posting detail level criterion, the inferred job posting market competitiveness criterion, and the job posting compensation information criterion for different job type and job location combinations of the multiple job types and the multiple job locations.

15. The non-transitory computer readable medium of claim 14, wherein the operations for determining the initial score and the one or more recommendations comprise:
determining weights of the different weights to use for the job posting based on a job type and job location combination associated with the job posting, wherein the weights include a first weight corresponding to job posting detail level of the job posting, a second weight corresponding to an inferred job posting market competitiveness of the job posting, and a third weight corresponding to job posting compensation information for the job posting; and
inferencing, using the unsupervised machine learning model, the first information according to the first weight, the second weight, and the third weight.

16. An apparatus, comprising:
a memory; and
a processor configured to execute instructions stored in the memory to:
determine, for a job posting for publication via a software service, an initial score and one or more recommendations for increasing the initial score by using a machine learning model trained based on a job posting corpus accessible to the software service to evaluate information associated with the job posting; and
present, within a graphical user interface for the job posting, the initial score and interactive prompts for updating the job posting according to the one or more recommendations.

17. The apparatus of claim 16, wherein the information associated with the job posting is first information, and wherein the processor is further configured to:
determine, in real-time in response to second information obtained by the software service from one or more web forms accessible via the interactive prompts, an updated score for the job posting by using the machine learning model to evaluate the first information and the second information; and
present the updated score within the graphical user interface.

18. The apparatus of claim 17, wherein the initial score is presented within the graphical user interface via a visualization, and
wherein, to present the updated score within the graphical user interface, the processor is configured to execute the instructions to:
update the visualization to in real-time in response to the updated score.

19. The apparatus of claim 16, wherein the machine learning model assigns different weights to one or more criteria for different job type and job location combinations derived from multiple job types and multiple job locations, and
wherein the one or more criteria correspond to a job posting detail level, an inferred job posting market competitiveness, and job posting compensation information.

20. The apparatus of claim 19, wherein, to determine the initial score and the one or more recommendations, the processor is configured to execute the instructions to:
determine weights of the different weights to use for the job posting based on a job type and job location combination associated with the job posting, wherein the weights include a first weight corresponding to job posting detail level of the job posting, a second weight corresponding to an inferred job posting market competitiveness of the job posting, and a third weight corresponding to job posting compensation information for the job posting; and inference, using the machine learning model, the information associated with the job posting according to the first weight, the second weight, and the third weight.
